(19) United States
(12) Patent Application Publication
(10) Pub. No.: US 2004/0125783 A1
(43) Pub. Date: Jul. 1, 2004

(54) State machine for data link control

(76) Inventors: Yu-Jen Hsueh, Taoyuan City (TW); Hsi-Kun Chen, Taichung (TW)

Correspondence Address: BIRCH STEWART KOLASCH & BIRCH, PO BOX 747, FALLS CHURCH, VA, 22040-0747, US

(21) Appl. No.: 10/425,877

(22) Filed: Apr. 30, 2003

(30) Foreign Application Priority Data
Dec. 31, 2002 (TW) 091138169

(51) Int. Cl. H04J 3/00

(52) U.S. Cl. 370/345; 370/350

(57) ABSTRACT

A state machine for data link control is implemented in the state management of a second layer protocol of a subscriber unit, which establishes message transmissions and management with an RP and an RPCU. In an acquiring state, the subscriber unit scans frequencies to find an available channel and downlinks information of system channels from the RPCU. The system channels include a first channel and a second channel. In a standby state, the subscriber unit keeps receiving the information, and the standby state includes an initial state, an idle state, and a time slot waiting state. The initial state is for determining and comparing the information and confirming whether the first channel is changed and whether the subscriber unit is registered. The idle state is to wait for a message that requests to establish a TC from the third layer protocol and to determine whether the second channel belongs to normal call messages, informing the third layer protocol to make a corresponding response. The time slot waiting state is to wait the RPCU to reply whether the TC is successfully established. The state machine enters the initial state when it searches and synchronizes with a specific channel in the acquiring state, enters the idle state after a complete first channel message is received in the initial state, and returns to the idle state if no TC establishment fails. Once the TC is successfully established in the time slot waiting state, the subscriber unit enters an active state.

### BACKGROUND OF THE INVENTION

1. Field of Invention

The invention relates to a state machine for data link control and, in particular, to a state machine that facilitates the states for management and control on the second layer of the communication protocol.

2. Related Art

Personal Access Communications System (PACS) is a wireless interface standards specified by American National Standards Institute (ANSI) in the 1.9 GHz PCS (Personal Communications System) band. This personal mobile communication technology can provide high voice quality (32 kbps voice coding), quick data transmissions, and large usable bandwidths. The structure of PACS is shown in FIG. 1. The subscriber unit 1, which may be a portable handset or a fixed access unit, communicates with others via radio ports (RP) 2, which are connected to and controlled by a radio port control unit (RPCU) 3. The RPCU 3 is connected to a public switched telephone network (PSTN) 4 that provides the control and management functions between the RP's and the PSTN 4.

In the Digital European Cordless Telecommunications (DECT) system, the communication protocol usually contains a physical layer, a medium access control layer, a data link control layer, and a network layer. In PACS, the communication protocol has three layers. The first layer is a physical layer. The second layer is a data link layer for monitoring and maintaining the functionality of wireless links. The third layer is in charge of the procedures of registration, sending messages, receiving incoming calls, and finishing calls. In practice, the design and implement of the second layer protocol is always the most important key to good wireless communication quality.

In the explanation of the second layer protocol of the subscriber unit, the PACS Air Interface Rev. A manual describes that the wireless link of the subscriber unit includes four states. As shown in FIG. 2, these states are an off state 5, an acquiring state 6, a standby state 7 and an active state 8. If the subscriber unit 1 is turned on from the off state 5 (S201), the subscriber unit 1 enters the acquiring state 6 and starts to scan frequencies to find an available RP channel. When the subscriber unit 1 synchronizes with a system broadcast channel (SBC) of RP 2, it starts to receive necessary information such as system information channels (SIC) and enters the standby state 7 after the synchronization (S203). In the standby state 7, the subscriber unit 1 keeps receiving SBC messages and determines whether to register to obtain the alert 1D assigned by the RPCU 3. If the subscriber unit 1 synchronizes with a traffic channel (TC), it becomes active (S205) and enters the active state 8. If the TC is released following the normal procedure, the communication is terminated (S206) and the subscriber unit 1 returns to the standby state 7. If the subscriber unit 1 loses synchronization, fails in the automatic link transfer attempt (S207), or loses synchronization in the standby state 7 (S204), it returns to the acquiring state 6 to keep searching for an available TC. If the subscriber unit 1 is turned off in the acquiring state 6 (S202), the subscriber unit 1 returns to the off state 5. Situations of turning off the subscriber unit 1 in the standby state 7 and the active state 8 are the same.

In the acquiring state 6, the PACS Air Interface Rev. A manual mentions that the subscriber unit 1 needs to find an available RP in order to synchronize with one SBC. It does not say that before the subscriber unit 1 enters the standby state 7, one needs to perform relevant parameter identification and candidate channel list initialization, so that the candidate channel list can be established and the subscriber unit 1 is prepared for automatic link transfer or time slot transfer. Such procedures are not detailed in the PACS Air Interface Rev. A manual. Moreover, the PACS Air Interface Rev. A does not mention any concrete mechanism or procedure that precede the above events in the standby state 7. In the standby state 7, after receiving the alert channel (AC) message (the SBC contains both SIC and AC), the subscriber unit 1 should execute the next action according to the state or instruction of the AC message. It is also necessary to integrate the function of emergency calls into the standby state, which is particularly important for natural disasters (such as earthquakes, floods, fires, and tornados) and terrorist events.

From the above description, we learn that there needs to be several new mechanisms and functions regarding the acquiring state 6 and the standby state 7 incorporated into the PACS Air Interface Rev. A manual. This will facilitate the control and management of the above two states and the active state, effectively establishing and increasing the stability of data links and the communication quality.

For further details of the PACS communication system standards, one can refer to the following references: the U.S. TIA publication JTC(AIR)/95.4.20-033R2 for the standards of the PACS system, the ANSI publication ANSI J-STD-014 for the cordless transmission standards in the PACS communication system, and the Bellcore Corp. publication TR-INS-001313 for the basic specifications of wireless access communication systems (WACS). We hereby assume that the readers are skilled in the field and familiar with the above standards and specifications.

### SUMMARY OF THE INVENTION

In view of the foregoing, it is an objective of the invention to provide a state machine for data link control, making the state management of the acquiring, standby and active states more convenient to control and process.

Another objective of the invention is to define respective events for the acquiring state and the standby state. The standby state is further divided into several states so that each event in the states can be processed without interference so as to achieve effective state management.

To achieve the above-mentioned objectives, the invention provides a state machine for data link control, which is implemented for state management of a second layer protocol on a subscriber unit. The subscriber unit establishes message transmissions and management with an RP and an RPCU in order. The state machine has an acquiring state, a standby state, and an active state. In the acquiring state, the subscriber unit scans frequencies to find an available channel and downlinks system channel information from the RPCU. The system channels include a first channel and a second channel. In the standby state, the subscriber unit keeps receiving the system channel information. The standby state includes an initial state, an idle state, and a time slot waiting state. The initial state is for determining and comparing the system information and confirming whether the first channel is changed and whether the subscriber unit is registered. When the subscriber unit searches and synchronizes with a specific channel in the acquiring state, it enters the initial state. The idle state is to wait for a message that requests to establish a TC from the third layer protocol, to determine whether the second channel belongs to normal call messages, and to inform the third layer protocol to make a corresponding response. After a complete first channel message is received in the initial state, the subscriber unit enters the idle state. The time slot waiting state is to wait the RPCU to reply whether or not the TC is successfully established. The time slot waiting state is transited to the idle state if the TC is successfully established. Once the TC is successfully established in the time slot waiting state, the subscriber unit enters the active state.

### BRIEF DESCRIPTION OF THE DRAWINGS

The invention will become more fully understood from the detailed description given hereinbelow illustration only, and thus are not limitative of the present invention, and wherein:

FIG. 1 is a structural diagram of a PACS;

FIG. 2 is a state diagram of a conventional subscriber unit in the second layer protocol;

FIG. 3 is a state flowchart of the subscriber unit in the second layer protocol according to a preferred embodiment of the invention; and

FIGS. 4A to 4F are flowcharts of each state in the second layer protocol according to the preferred embodiment of the invention.

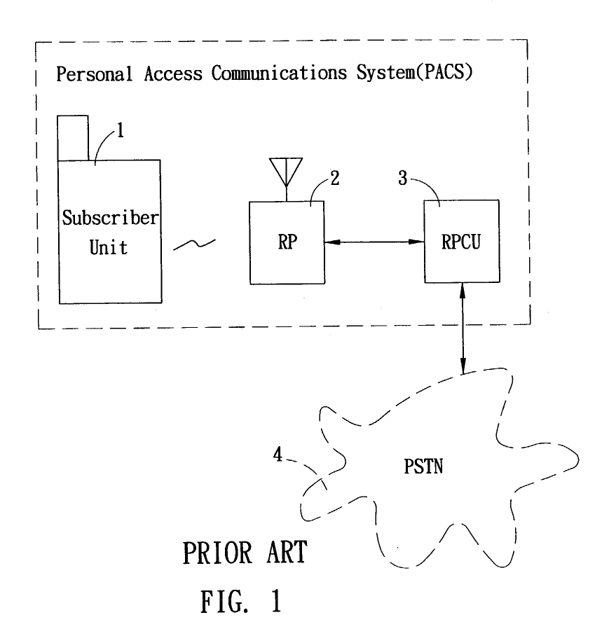

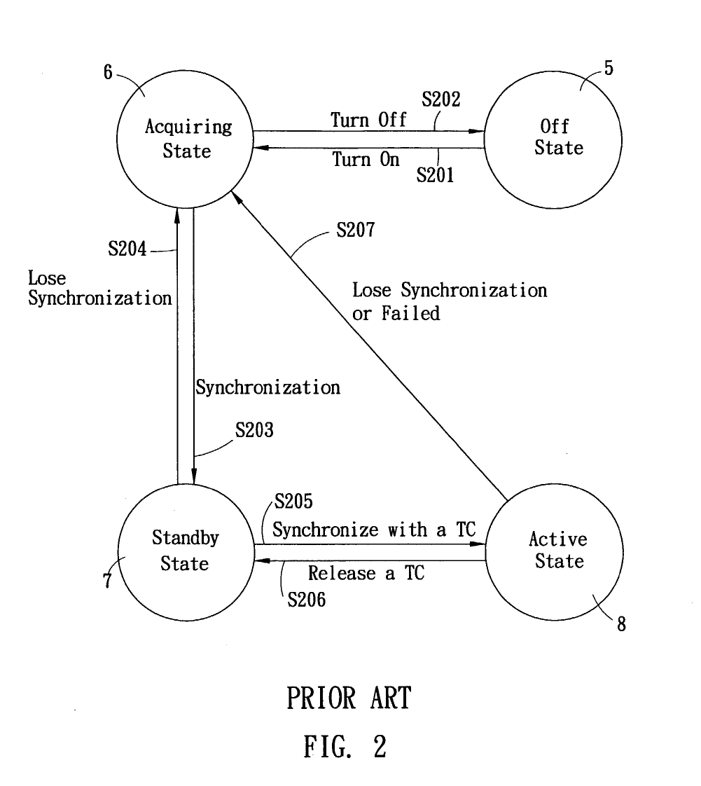

### DETAILED DESCRIPTION OF THE INVENTION

The present invention will be apparent from the following detailed description, which proceeds with reference to the accompanying drawings, wherein the same references relate to the same elements.

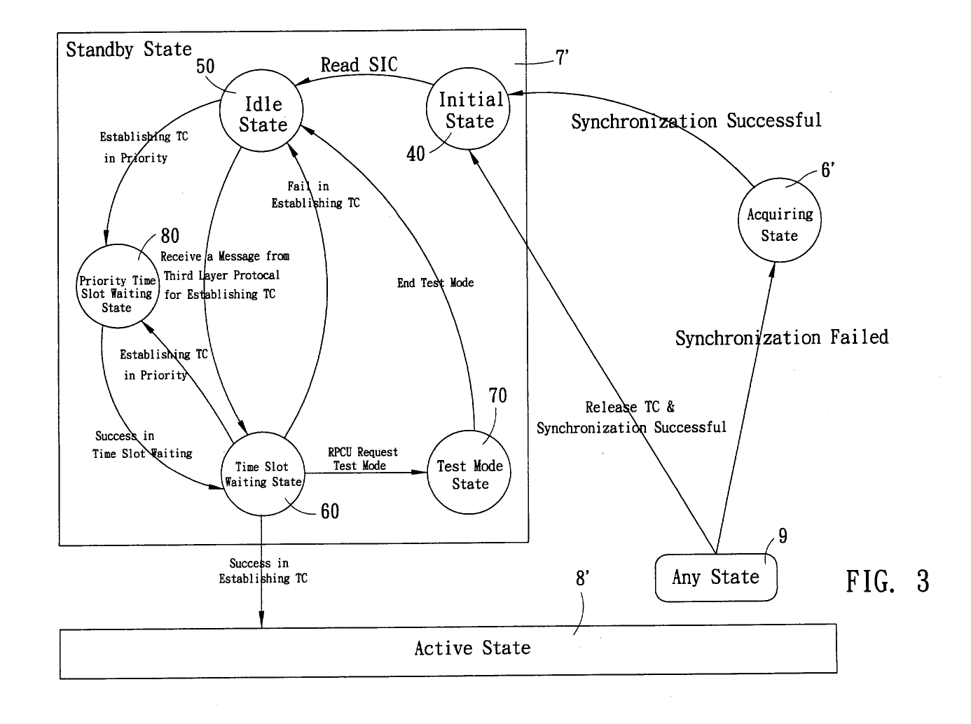

Please refer to FIG. 3. In the current embodiment, the standby state 7′ according to the invention is further divided into an initial state 40, an idle state 50, a time slot waiting state 60, a test mode state 70, and a priority time slot waiting state 80. When the subscriber unit loses synchronization in any of the acquiring state 6′, the standby state 7′, and the active state 8′, it returns to the acquiring state 6′. If the subscriber unit is about to break the link or requires synchronization with an RP, it returns to the initial state 40 from any state (block 9).

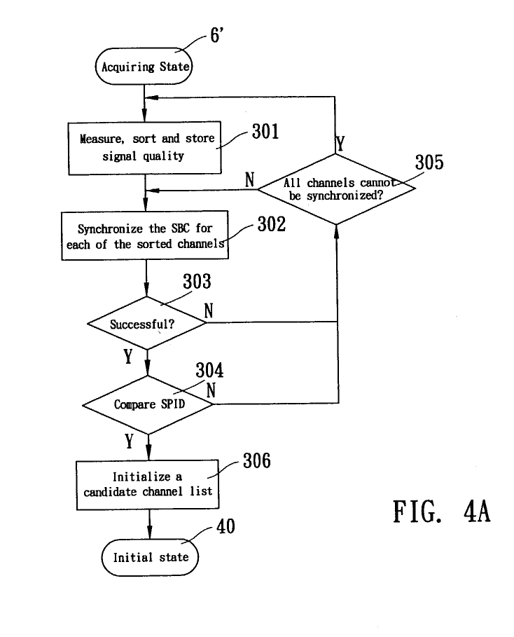

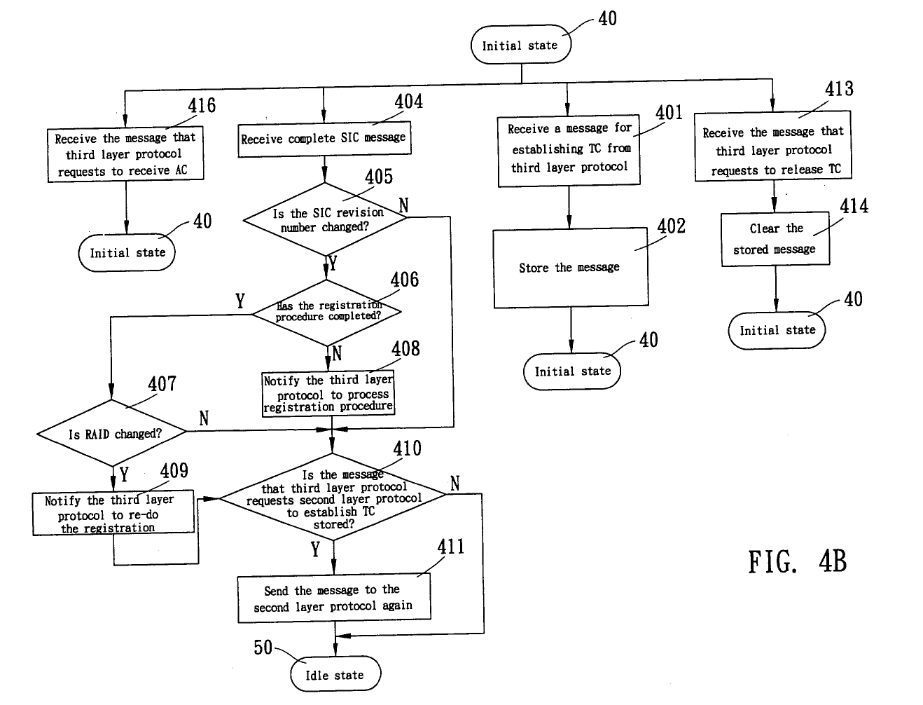

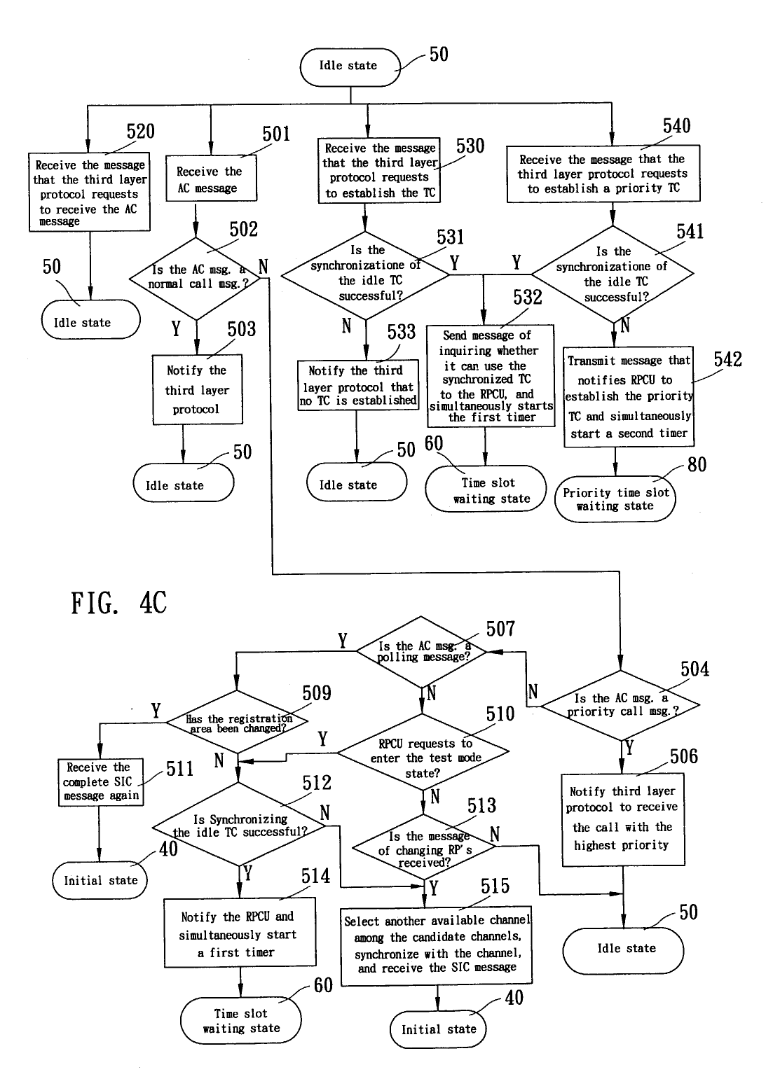

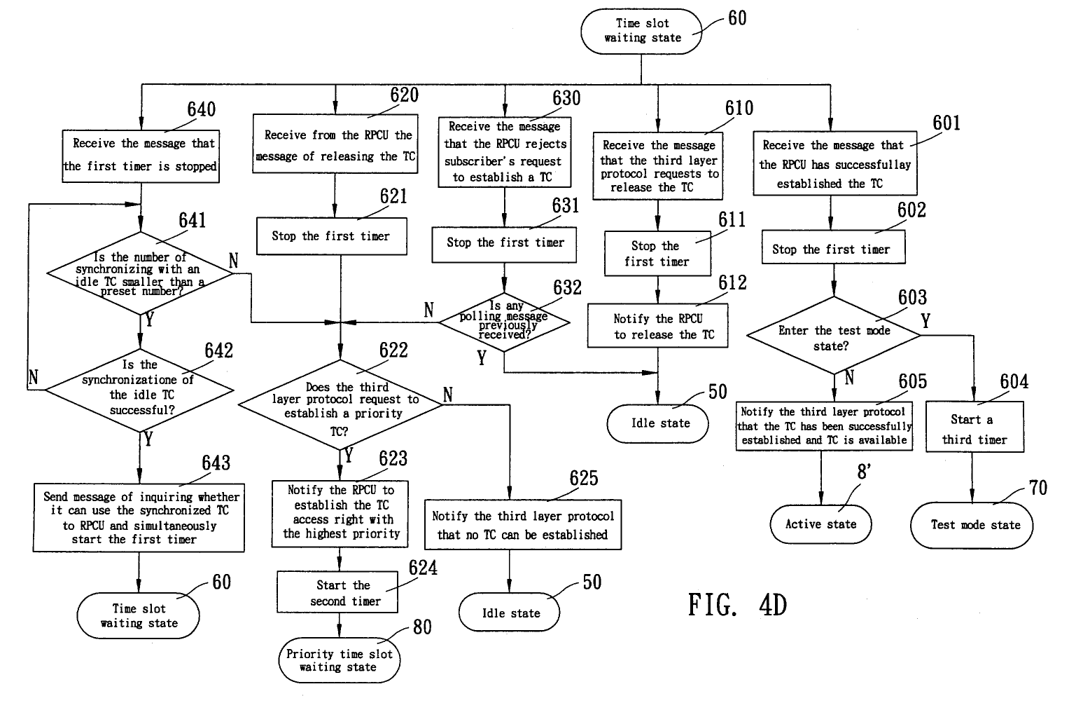

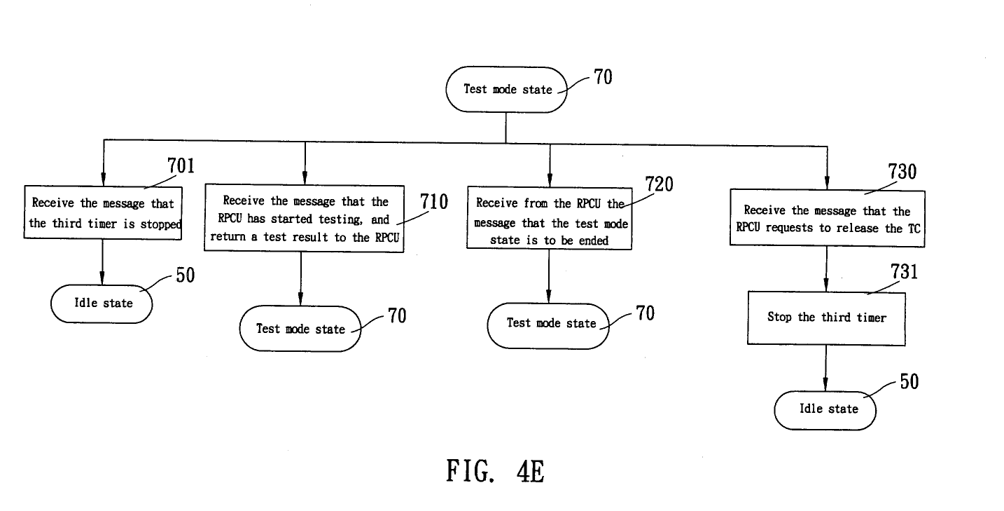

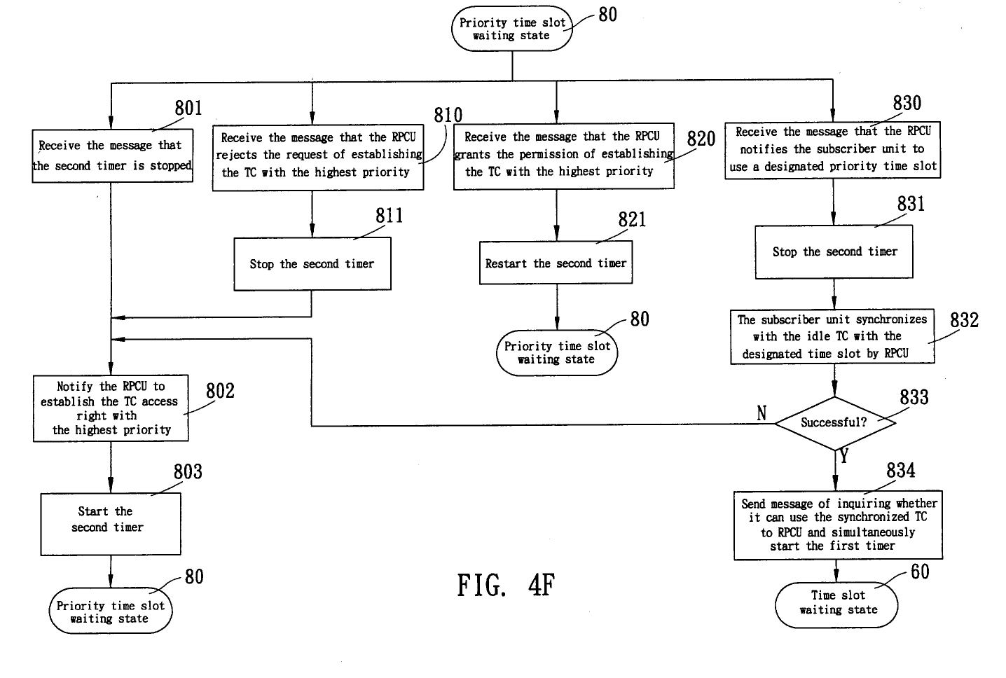

In this embodiment, the PACS provides 50 pairs of channels, each of which contains uplink and downlink frequencies. In a real system, the frequencies of the PACS are divided into three sets of channels. Each set has 16 pairs of channels and each channel in use is 300 kHz apart from one another. As shown in FIG. 4A, the subscriber unit enters the acquiring state 6′ immediately after it is turned on. The detailed steps are described as follows:

Step 301: For all channels stored inside the subscriber unit, measure, sort and store signal quality such as the received signal strength indication (RSSI) and quality indication (QI).

Step 302: Synchronize the SBC for each of the sorted channels.

Step 303: Go on to step 304 if the synchronization is successful; otherwise, perform step 305 to synchronize the other channel.

Step 304: The subscriber unit starts to read the SIC downlinked from the RPCU. It should be noted that the SBC contains an SIC and an AC. The SIC is divided into an SIC header and an SIC body. The SIC header contains a service provider ID (SPID), an SIC revision number, and a service capability and security menu. The SIC body contains a registration area ID (RAID) and communication protocol related parameters. Step 304 compares the SPID downlinked from the RPCU and the SPID inside the subscriber unit, determining whether the subscriber unit is available for the service provider. If unavailable, the procedure goes on to step 305 to try for the other channel.

Step 305: If all channels cannot be synchronized, the subscriber unit waits a period of time and returns back to step 301 for further tries. Otherwise, the procedure goes to step 302.

Step 306: Initialize a candidate channel list and use the 16 pairs of channels corresponding to the synchronized channel as the predetermined channel list. The best three channels in signal quality form the candidate channel list for handover when entering the active state. This step is followed by the step of entering the initial state 40.

The initial state 40 shown in FIG. 4B mainly keeps receiving all parameters in the SIC message, and determines whether any parameter is changed. The detailed steps in the initial state 40 are as follows:

Step 401: Receive a message for establishing the TC from the third layer protocol. The request for establishing the TC occurs under the situations of normal calls and emergency calls.

Step 402: Store the message that the third layer protocol requests the second layer protocol to establish the TC. The purpose of this step is to prevent from losing the message that the third layer protocol requests the second layer protocol to establish the TC in the initial state 40. The next step returns to the initial state 40.

Step 404: Under the following two conditions, the subscriber unit will enter the initial state 40:

First condition: When the acquiring state 6′ is transited to the initial state 40, all parameters in the SIC message downlinked from the RPCU are being received until the complete SIC message is received.

Second condition: When the subscriber unit disconnects the link in any state of the second layer protocol and returns back to the initial state 40, only part of the information of the SIC header is necessary to be read in.

Step 405: Check whether the SIC revision number is changed. If it is changed, go to step 406; otherwise, go to step 410.

Step 406: Determine whether the subscriber unit has completed the registration procedure in the third layer protocol. If the registration is successful, an alert ID will be simultaneously obtained and the process continues to step 407. If not, go to step 408.

Step 407: Compare the RAID in the SIC message with that stored inside the subscriber unit, checking whether it is changed. If it is changed, go to step 409; otherwise, go to step 410.

Step 408: Notify the third layer protocol to process the registration procedure.

Step 409: Notify the third layer protocol that the registration area has been changed and re-do the registration.

Step 410: Determine whether the message that the third layer protocol requests the second layer protocol to establish the TC is stored. If it is stored, go to step 411; otherwise, go to the idle state 50.

Step 411: Send the message that the third layer protocol requests the second layer protocol to establish the TC to the second layer protocol again, and go on to the idle state 50.

Step 413: Receive the message that the third layer protocol requests to release the TC.

Step 414: Clear the stored message that the third layer protocol requests the second layer protocol to establish the TC, and go back to the initial state 40.

Step 416: Receive the message that the third layer protocol requests to receive the AC, and go back to the initial state 40.

The idle state 50, as shown in FIG. 4C, mainly waits for the message that the third layer protocol requests to establish the TC and determines the state of the received AC message for subsequent actions. The detailed steps in the idle state 50 are as follows:

Step 501: Receive the AC message from the RPCU.

Step 502: Determine whether the AC message is a normal call message. If so, then go to step 503 (meaning that the AC message downlinked from the RPCU has the same alert ID as the subscriber unit); otherwise, go to step 504.

Step 503: Notify the third layer protocol that it is a normal call message and the third layer protocol establishes the TC accordingly. The next step is to go back to the idle state 50.

Step 504: Determine whether the AC message is a priority call message. If it is, then go to step 506; otherwise, go to step 507.

Step 506: Notify the third layer protocol to receive the call with the highest priority, and go back to the idle state 50 in the next step.

Step 507: Determine whether the AC message is a polling message sent from the RPCU. If it is, then go to step 509; otherwise, go to step 510. The polling message sent out from the RPCU is mainly used to periodically check whether the subscriber unit is still in the original registration area.

Step 509: Determine whether the registration area of the subscriber unit has been changed. If so, then go to step 511; otherwise, go to step 512.

Step 510: Determine whether the AC message is to enter the test mode state. If so, go to step 512; otherwise, go to step 513.

Step 511: Receive again the complete SIC message and return to the initial state 40 in the next step.

Step 512: Synchronize the idle TC. If the synchronization is successful, then go to step 514; otherwise, go to step 515.

Step 513: Determine whether the message of changing RPs sent out from the RPCU is received. If so, then go to step 515; otherwise, go back to the idle state 50.

Step 514: Notify the RPCU with the message that the subscriber unit is still in the original registration area and simultaneously start a first timer. The next step is to enter the time slot waiting state 60.

Step 515: Select another available channel among the candidate channels, synchronize with the channel and receive the SIC message. The next step returns back to the initial state 40.

Step 520: Receive the message that the third layer protocol requests to receive the AC message. The next step returns to the idle state 50.

Step 530: Receive the message that the third layer protocol requests to establish the TC.

Step 531: Determine whether the synchronization of the idle TC is successful. If the synchronization is successful, then go to step 532; otherwise, go to step 533.

Step 532: The subscriber unit sends a message of inquiring whether or not the subscriber unit can use the synchronized TC to the RPCU and simultaneously starts the first timer. The next step is to enter the time slot waiting state 60.

Step 533: Notify the third layer protocol that no TC is established and the next step returns to the idle state 50.

Step 540: Receive the message that the third layer protocol requests to establish a priority TC.

Step 541: Determine whether the synchronization of the idle TC is successful. If the synchronization is successful, then go to step 532; otherwise, go to step 542.

Step 542: The subscriber unit transfers the message that notifies the RPCU should establish the priority TC via the SBC and simultaneously starts a second timer. The next step is to enter the priority time slot waiting state 80. It is worth emphasizing here that the RPCU usually forces a TC in use to be available and assigns it to the subscriber unit immediately after receiving the message.

The time slot waiting state 60, as shown in FIG. 4D, mainly waits for the message that the RPCU has successfully established the TC or what to do when no TC is established. The detailed steps in the time slot waiting state 60 are as follows:

Step 601: Receive the message that the RPCU has successfully established the TC.

Step 602: Stop the first timer.

Step 603: Determine whether or not to enter the test mode state 70. If so, then go to step 604; otherwise, go to step 605.

Step 604: Start a third timer, followed by the step of entering the test mode state 70.

Step 605: Notify the third layer protocol that the TC has been successfully established and the TC is available. The next step is to enter the active state 8′.

Step 610: Receive that message that the third layer protocol requests to release the TC. This happens when the user hangs up the telephone before the connection is established.

Step 611: Stop the first timer.

Step 612: Notify the RPCU to release the TC, followed by the step of returning to the idle state 50. It should be noticed that the next step could be to again receive a complete SIC message and to go back to the initial state 40.

Step 620: Receive from the RPCU the message of releasing the TC. This may happen when the communication quality is extremely bad. The RPCU determines to take back the TC access right.

Step 621: Stop the first timer.

Step 622: Determine whether the third layer protocol requests to establish a priority TC. If so, then go to step 623; otherwise, go to step 625.

Step 623: Notify the RPCU to establish the TC access right with the highest priority.

Step 624: Start the second timer, followed by the step of entering the priority time slot waiting state 80.

Step 625: Notify the third layer protocol that no TC can be established, followed by the step of returning to the idle state 50. It should be noticed that the next step could be to again receive a complete SIC message and to go back to the initial state 40.

Step 630: Receive the message that the RPCU rejects the subscriber's request to establish a TC. This may happen when several users want to establish TCs at the same time. However, when the idle TCs are not available, only some users can establish the connections while the RPCU sends rejections to others.

Step 631: Stop the first timer.

Step 632: Determine whether any polling message is previously received from the RPCU. If there is, then enter the idle state 50; otherwise, go to step 622.

Step 640: Receive the message that the first timer is stopped. This message means that after entering the time slot waiting state 60, if no reply from the RPCU about successful TC establishment is received, the above message will be received when the timer is stopped.

Step 641: Suppose the number of synchronizing with an idle TC is smaller than a preset number, and then go to step 642. If the number of synchronizing with an idle TC is larger than the preset number, then go to step 622.

Step 642: Determine whether the synchronization of the idle TC is successful. If the synchronization is successful, then go to step 643; otherwise, return to step 641 and repeat the TC synchronization.

Step 643: The subscriber unit sends the message of inquiring whether it can use the synchronized TC to the RPCU and simultaneously starts the first timer, followed by the step of returning to the time slot waiting state 60.

The test mode state 70, as shown in FIG. 4E, mainly enables the RPCU to send test commands to the subscriber unit. When the RPCU wants to notify the subscriber unit to perform tests of relevant services (such as parameter tests), the subscriber unit enters this state. The detailed steps in the test mode state 70 are as follows:

Step 701: Receive the message that the third timer is stopped, followed by the step of returning to the idle state 50. This message means that the RPCU has not ended the test mode state 70 normally. Since the subscriber unit and the RPCU cannot communicate during the test mode state 70, the time spent in this state cannot be too long.

Step 710: Receive the message that the RPCU has started testing. After the test, the subscriber unit returns a test result to the RPCU. The next step is to return to the test mode state 70. It should be mentioned that step 710 would be repeated several times according to the test items performed by the RPCU.

Step 720: The subscriber unit receives from the RPCU the message that the test mode state is to be ended, followed by the step of returning to the test mode state 70.

Step 730: Receive the message that the RPCU requests to release the TC, and finish the test mode state 70.

Step 731: The subscriber unit stops the third timer. Then, the test mode state 70 is transited to the standby state 50.

The priority time slot waiting state 80, as shown in FIG. 4F, mainly waits for the RPCU's reply about whether or not to establish the TC with the highest priority or what to do when no TC can be established. The detailed steps in the priority time slot waiting state 80 are as follows:

Step 801: Receive the message that the second timer is stopped. This message means that after entering the priority time slot state 80, such a message will be received when no reply about establishing the TC with the highest priority from the RPCU and the second timer is stopped.

Step 802: Notify the RPCU to establish the TC access right with the highest priority.

Step 803: Start the second timer, followed by the step of returning to the priority time slot waiting state 80.

Step 810: Receive the message that the RPCU rejects the request of establishing the TC with the highest priority.

Step 811: Stop the second timer and go to step 802.

Step 820: Receive the message that the RPCU grants the permission of establishing the TC with the highest priority.

Step 821: Restart the second timer, followed by the step of returning to the priority time slot waiting state 80.

Step 830: Receive the message that the RPCU notifies the subscriber unit to use a designated priority time slot.

Step 831: Stop the second timer.

Step 832: The subscriber unit synchronizes with the idle TC with the designated time slot by the RPCU.

Step 833: If the synchronization is successful, then go to step 834; otherwise, go to step 802.

Step 834: The subscriber unit sends the message of inquiring whether it can use the synchronized TC to the RPCU and simultaneously starts the first timer, followed by the step of returning to the time slot waiting state 60.

In summary, the state machine for data link control of the invention is mainly used for the state management for the second layer protocol of the subscriber unit. Each state is planned and configured in the state machine. In particular, events in the acquiring state and the standby state are distinctly defined, respectively. The standby state is further divided into the initial state, the idle state, the time slot waiting state, the priority time slot waiting state, and the test mode state according to the events. Each of the above states is defined with a specific procedure for the convenience of managing the flow. Accordingly, the invention can help establishing and promoting the stability of data links.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A state machine for data link control implemented in the state management of a second layer protocol of a communication protocol of a subscriber unit, the subscriber unit establishing message transmissions and management with a radio port (RP) and a radio port control unit (RPCU) in order, the state machine comprising:
an acquiring state, which scans frequencies to find an available channel and downlinks system channel information from the RPCU, the system channels comprising a first channel and a second channel;
a standby state, which receives the information, comprising:
an initial state, which compares the information to determine whether the first channel is changed and whether the subscriber unit is registered, the state machine enters the initial state when the acquiring state finds and synchronizes with a specific channel;
an idle state, which waits for a message that a third layer protocol of the communication protocol requests to establish a traffic channel (TC), determines whether the second channel belongs to normal calls, and notifies the third layer protocol to react accordingly, the state machine entering the idle state after the initial state receives a complete message from the first channel; and
a time slot waiting state, which waits for a message from the RPCU about whether or not the TC is successfully established, if unsuccessful, the state machine returning to the idle state; and
an active state, which starts after the TC is successfully established in the time slot waiting state.

2. The state machine of claim 1, wherein the system channels are system broadcast channels (SBC), the first channel is a system information channel (SIC), and the second channel is an alert channel (AC).

3. The state machine of claim 1, wherein the message that the third layer protocol requests to establish the TC is stored in advance when the message that the third layer protocol requests to establish the TC is received in the initial state.

4. The state machine of claim 1, wherein the idle state further determines whether the second channel belongs to priority call messages and, if so, the state machine notifies the third layer protocol to receive the call with the highest priority.

5. The state machine of claim 1, wherein the idle state further determines whether the second channel belongs to polling messages to determine whether the RP is in its original registration area.

6. The state machine of claim 1, wherein the standby state further comprises a test mode state, the state machine entering the test mode state from the time slot waiting state under an instruction of the RPCU.

7. The state machine of claim 1, wherein the idle state further determines whether the second channel belongs to messages of requesting to change the RP.

8. The state machine of claim 6, wherein the idle state further determines whether the second channel belongs to messages of requesting to enter the test mode state.

9. The state machine of claim 4, wherein the standby state further comprises a priority time slot waiting state so that when the message that the third layer protocol requests to establish the TC with the highest priority is received in the time slot waiting state, the time slot waiting state is transited into the priority time slot waiting state in which the RPCU designates a specific time slot for the subscriber unit to establish the TC with the highest priority.

10. The state machine of claim 4, wherein the idle state is transited into the priority time slot waiting state after receiving the message that the third layer protocol requests to establish the TC with the highest priority in the idle state.

11. A state machine for data link control implemented in the state management of a second layer protocol of a communication protocol of a subscriber unit, the subscriber unit establishing message transmissions and management with a radio port (RP) and a radio port control unit (RPCU) in order, the state machine comprising:
an acquiring state, which scans frequencies to find an available channel and downlinks information of system channels from the RPCU, the system channels comprising a first channel and a second channel;
a standby state, which receives the information, comprising:
an initial state, which compares the information to determine whether the first channel is changed and whether the subscriber unit is registered, the state machine entering the initial state when the acquiring state finds and synchronizes with a specific channel;
an idle state, which waits for a message that a third layer protocol of the communication protocol requests to establish a traffic channel (TC), determines whether the second channel belongs to normal calls or priority calls, and notifies the third layer protocol to react accordingly, the state machine entering the idle state after the initial state receives a complete message from the first channel; and
a time slot waiting state, which waits for a message replied from the RPCU about whether the TC is successfully established, if unsuccessful, the state machine returning to the idle state;
a test mode state, the state machine entering the test mode state from the time slot waiting state under an instruction of the RPCU; and
a priority time slot waiting state, which waits for a message that the RPCU designates a specific time slot for the subscriber unit to establish the TC, the time slot waiting state being transited into the priority time slot waiting state when the state machine receives a message that the third layer protocol requests to establish the TC with the highest priority in the time slot waiting state; and
an active state, which starts after the TC is successfully established in the time slot waiting state.

12. The state machine of claim 11, wherein the system channels are system broadcast channels (SBC), the first channel is a system information channel (SIC), and the second channel is an alert channel (AC).

13. The state machine of claim 11, wherein the message that the third layer protocol requests to establish the TC is stored in advance when the message that the third layer protocol requests to establish the TC is received in the initial state.

14. The state machine of claim 11, wherein the idle state is transited into the priority time slot waiting state after receiving the message that the third layer protocol requests to establish the TC with the highest priority.

15. The state machine of claim 11, wherein the idle state further determines whether the second channel belongs to polling messages to determine whether the RP is in its original registration area.

16. The state machine of claim 11, wherein the idle state further determines whether the second channel belongs to messages of requesting to enter the test mode state.
